(19) United States
(12) Patent Application Publication
(10) Pub. No.: US 2014/0339191 A1
(43) Pub. Date: Nov. 20, 2014

(54) Specimen Collection Container System

(71) Applicant: Parter Medical Products, Inc., Carson, CA (US)

(72) Inventor: Hormoz Foroughi, Carson, CA (US)

(73) Assignee: Parter Medical Products, Inc., Carson, CA (US)

(21) Appl. No.: 14/153,054

(22) Filed: Jan. 12, 2014

Related U.S. Application Data
(60) Provisional application No. 61/751,868, filed on Jan. 12, 2013.
(60) Provisional application No. 61/751,937, filed on Jan. 13, 2013.

(51) Int. Cl. A61J 1/14; B65D 41/38

(52) U.S. Cl. CPC A61J 1/1412; B65D 41/38; B65D 41/385; A61J 2001/1418
USPC 215/344; 215/350

(57) ABSTRACT

A specimen collection container having an improved sealing mechanism that provides enhanced sealing properties during transport, storage, and handling. The specimen collection container comprises a cup, cap and improved sealing mechanism. The sealing mechanism forms multiple seals between the cup and cap. In a preferred embodiment, the sealing mechanism forms primary, secondary and tertiary seals between the cap the cup. The primary and secondary seals are preferably formed between the cap and the interior surface of the cup. The tertiary seal is preferably formed between the cap and the distal edge of the cup. The first, second and third seals are sequentially formed as the cap is rotated from a first radial position at which the threads first engage each other to a second radial location at which the cap is fully closed. Each of the three seals on its own is capable of sealing the container and preventing a fluid specimen from leaking from the cup if the seal is maintained. The primary and secondary seals are constructed and arranged to seal the cup after the cup and cap are threadingly engaged independent of the amount of torque applied to the cap.

### CROSS REFERENCE TO RELATED APPLICATIONS

This application claims priority to provisional patent application No. 61/751,868, filed Jan. 12, 2013, entitled Specimen Collection Container System, and provisional application No. 61/751,937 filed Jan. 13, 2013, entitled Specimen Collection Container System, both of which are incorporated herein by reference.

### FIELD OF THE INVENTION

This invention relates to a specimen collection container having an improved sealing mechanism. More particularly, the invention relates to a specimen collection container having an improved sealing mechanism that provides enhanced sealing properties during transport, storage, and handling.

### BACKGROUND OF THE INVENTION

It is well known that specimen containers are used to collect and transport medical samples from a collection site to various locations for analysis. The prior art teaches a wide variety of specimen containers, which are often, but not always, made from deformable plastic. Frequently, these containers are “pre-filled” with preservatives or other chemicals that are required to preserve the sample and/or initiate the analysis process.

In many cases, after the container has been closed and sealed, it is subjected to significant environmental pressure changes either during shipping or handling. For example, the containers are often shipped by air freight from the manufacturer to the collection site, and/or from the collection site to a laboratory. Since the cargo area of an airplane is usually not pressured, the container is subjected to significant pressure changes during transport. Additionally, some test facilities use internal, pneumatic, tubular transportation systems to convey the containers from station to station within a test facility. These pneumatic transportation systems also subject the container to significant pressure changes.

When subjected to significant pressure changes, prior art specimen containers are known to leak for a variety of reasons. For example, enhanced pressure may cause the cap to loosen, may cause distortion of a cap seal, or may cause distortion of the cap itself. Whatever the cause, leakage is unacceptable, especially when the specimen within the container is toxic or infectious. Therefore, it would be desirable to provide a specimen container having a seal mechanism that provides improved sealing under significant pressure differential during shipping or transport.

In order to provide an improved seal on the specimen container, prior art devices may provide a more snug tolerance between the cap and the container, or a design that requires increased torque to fully close the lid. Some patients, especially elderly patients, may not have the hand strength to properly close the lids of such containers. Therefore, it would be desirable to provide a container having a seal mechanism that does not require excessive torque to completely close and seal the lid to prevent leaking.

On most prior art collection containers, the cap must be torqued a predetermined amount, i.e., twisted past a certain angular orientation, in order to properly close and fully seal the cap to the cup. Often the patient is unsure if he/she has torque/tightened the cap sufficiently to fully engage the sealing mechanism. If the cap us under torqued, the cup will not be fully sealed. If the cap is over torqued, the threads may be stripped and/or the sealing mechanism may be damaged. Therefore, it would be desirable to provide a specimen collection container having a mechanism that provides a detectible indicator when the cap has been sufficiently torqued to properly seal the lid to the cup.

### SUMMARY OF THE INVENTION

The present invention provides a specimen collection container having an improved sealing mechanism that provides enhanced sealing properties during transport, storage, and handling. In one preferred embodiment, the specimen collection container comprises a cup, cap and improved sealing mechanism.

The cup has a closed bottom end and an open upper end, a bottom surface at the closed end, sidewalls extending from the periphery of the bottom surface and terminating at a distal upper edge, and threads formed on the upper, outer surface of the side walls. The cap has a closed top end and an open bottom end, a top surface at the closed upper end, sidewalls extending from the periphery of the top surface and terminating at a distal lower edge, and threads formed on the interior surface of the side walls that compliment and engage the threads on the cup to open and close the cap on the cup.

The sealing mechanism forms multiple seals between the cup and cap. In a preferred embodiment, the sealing mechanism forms primary, secondary and tertiary seals between the cap the cup. The primary and secondary seals are preferably formed between the cap and the interior surface of the cup. The tertiary seal is preferably formed between the cap and the distal edge of the cup. The first, second and third seals are sequentially formed as the cap is rotated from a first radial position at which the threads first engage each other to a second radial location at which the cap is fully closed. Each of the three seals on its own is capable of sealing the container and preventing a fluid specimen from leaking from the cup if the seal is maintained.

In a preferred embodiment, the primary and secondary seals comprise a plug that extends from the cap and engages the interior surface of the cup at two separate locations. The plug is integrally formed with and extends downwardly from the top wall of the cap, and has an inner plug surface, an outer plug surface and a distal end surface. The inner plug surface has a flat, regular geometry and extends axially at an obtuse angle relative to the plane of the central portion of the cap. The outer plug surface has an irregular geometry and also extends at an obtuse angle relative to the plane of the central portion of the cap. In one preferred embodiment, the primary seal and a secondary seal comprise protrusions on the outer plug surface, which contact the inner surface of the upper portion of the sidewall of the cup.

The primary and secondary seals are constructed and arranged to seal the cup after the cup and cap are threadingly engaged independent of the amount of torque applied to the cap. Therefore, the cup will be sealed even if sufficient torque has not been applied to close the cap fully and to engage the tertiary seal.

The tertiary seal preferably comprises an annular seat in the cap having a shape that compliments the shape as the distal edge of cup. The annular seat is preferably integrally formed on the cap intermediate the annular plug and support bead.

The collection container also preferably includes a support mechanism on the cap that engages the outer surface of the cup at support locations opposed to at least one of the seals. In a preferred embodiment the support mechanism supports the cup at locations generally opposed to the primary and secondary seals.

The cap includes reinforcing means on the top surface and the sidewall. The cap reinforcing means preferably comprises a plurality of radially-projecting strengthening ribs on the interior surface of the central, circular portion, and a plurality of equally-spaced, radially-projecting gussets on the outer surface.

The cup may also include reinforcing means on the sidewall. The cup reinforcing means preferably comprises a strengthening ring that extends around the periphery of the outer surface. The cup reinforcing means may also comprise a plurality of radially-extending strengthening ribs on the bottom surface.

The specimen container may also include an indicator that informs the user whether or not the cap is fully closed on the cup. In one embodiment, the indicator comprises a detent mechanism that creates at least one audible click sound when the cap is fully closed. In another embodiment, the indicator is visual and includes an arrow on the cap and a series of bar on the cup, which align when the cap is fully closed.

### BRIEF DESCRIPTION OF THE DRAWINGS

FIG. 1 is an exterior, perspective view of the top cap of the collection container in accordance with an embodiment of the invention;

FIG. 2 is a top plan view of the cap shown in FIG. 1;

FIG. 3 is a side elevation of the cap shown in FIG. 1;

FIG. 4 is a FIG. 1 is an interior, perspective view of the cap shown in FIG. 1;

FIG. 5 is a bottom plan view of the cap shown in FIG. 1;

FIG. 6 is a perspective view of the cup of the collection container in accordance with an embodiment of the invention;

FIG. 7 is a top plan view of the cup shown in FIG. 6;

FIG. 8 is a side elevation of the cup shown in FIG. 7;

FIG. 9 is a cross-section of the collection container showing initial engagement of the cap and cup;

FIG. 10 is an enlarged section of the sealing mechanism of the collection container shown in FIG. 9;

FIG. 11 is a cross-section of the collection container showing intermediate (partially-closed) engagement of the cap and cup 14;

FIG. 12 is an enlarged section of the sealing mechanism of the collection container shown in FIG. 11;

FIG. 13 is a cross-section of the collection container showing final (fully-closed) engagement of the cap and cup;

FIG. 14 is an enlarged section of the sealing mechanism of the collection container shown in FIG. 13;

FIG. 15 is a perspective view of a cup in accordance with another embodiment of the invention;

FIG. 16 is a side elevation of the cup shown in FIG. 15;

FIG. 17 is a top plan view of the cup shown in FIG. 15;

FIG. 18 is front elevation of the cup shown in FIG. 15;

FIG. 19 is a bottom plan view of the cup shown in FIG. 15; and

FIGS. 20-25 illustrate additional features in accordance with further embodiments of the invention.

### DESCRIPTION OF PREFERRED EMBODIMENTS

For the purpose of illustration, there is shown in the accompanying drawings several embodiments of the invention. However, it should be understood by those of ordinary skill in the art that the invention is not limited to the precise arrangements and instrumentalities shown therein and described below. To more clearly illustrate the invention, the drawings are not necessarily to scale.

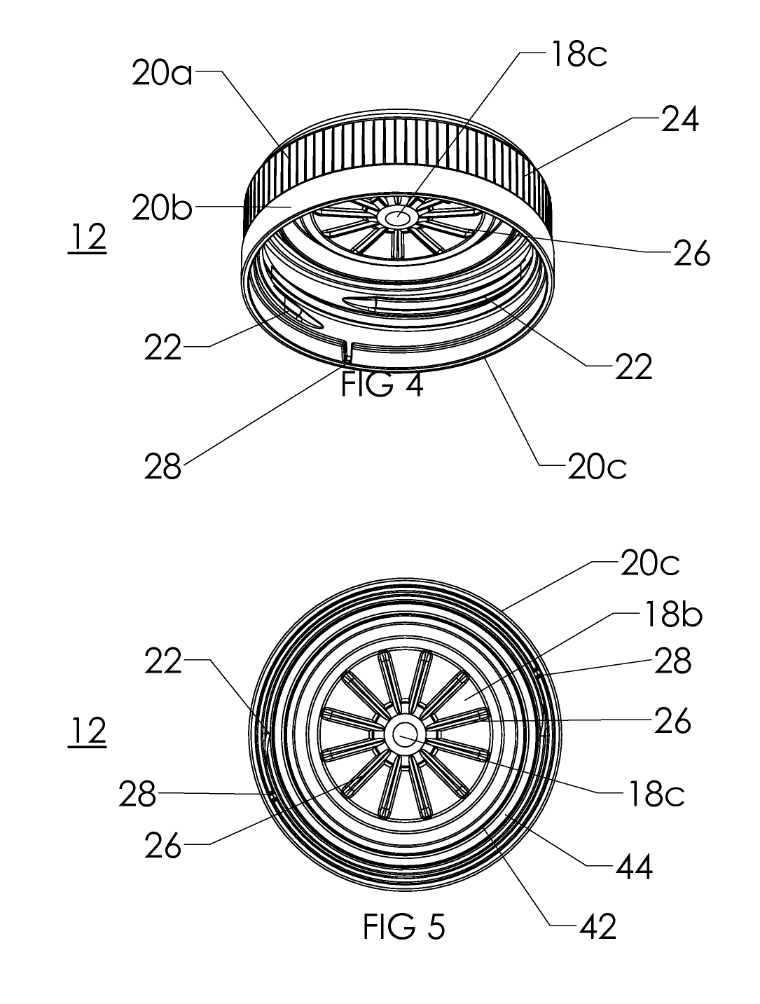

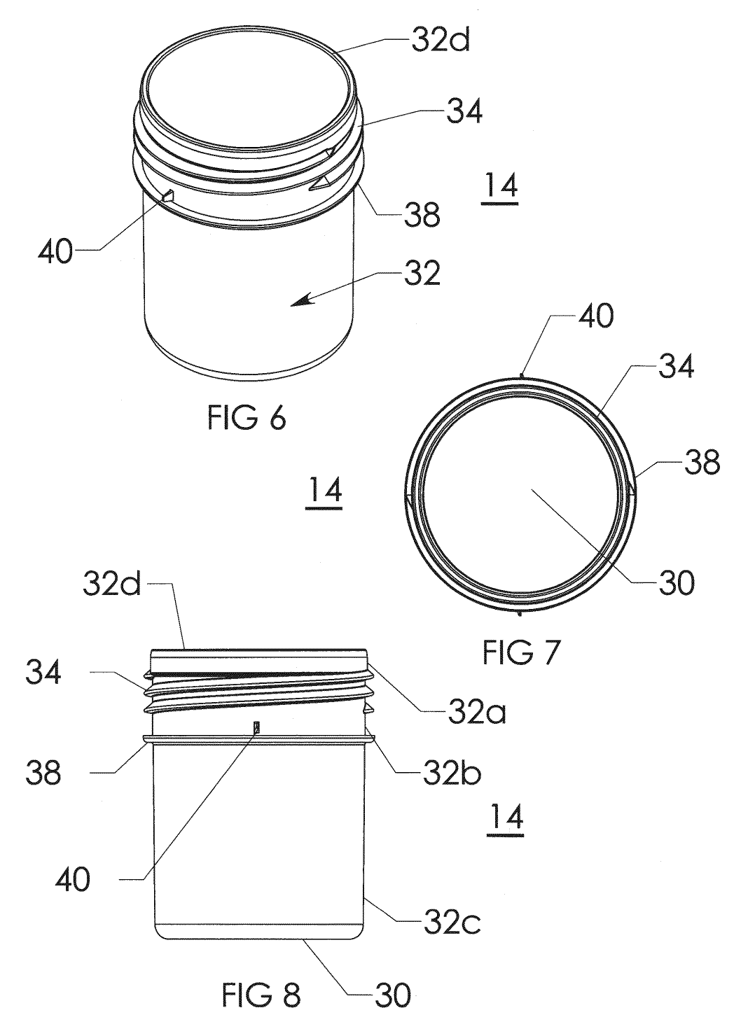

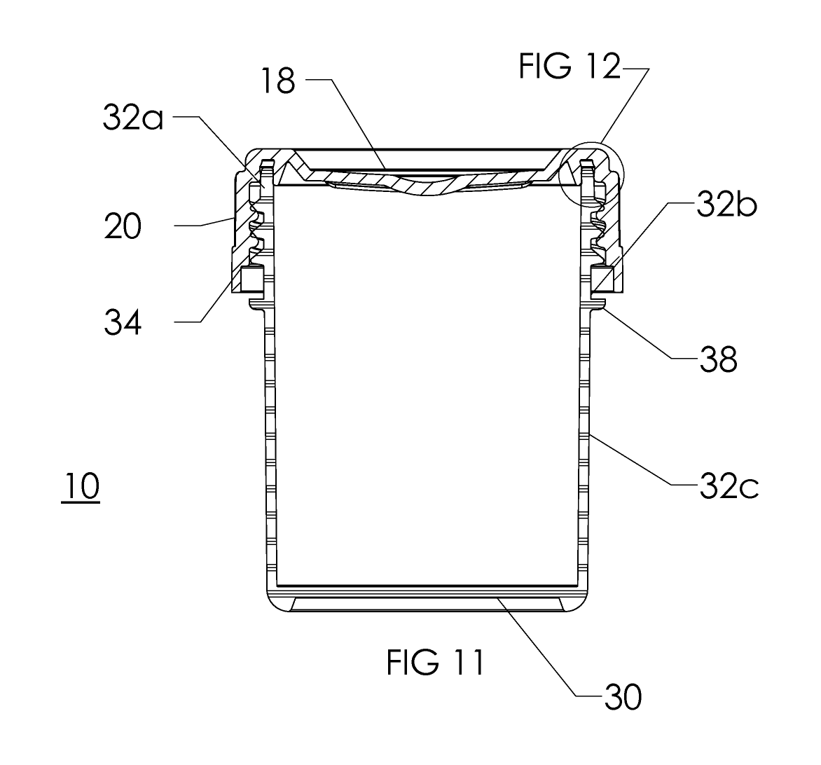

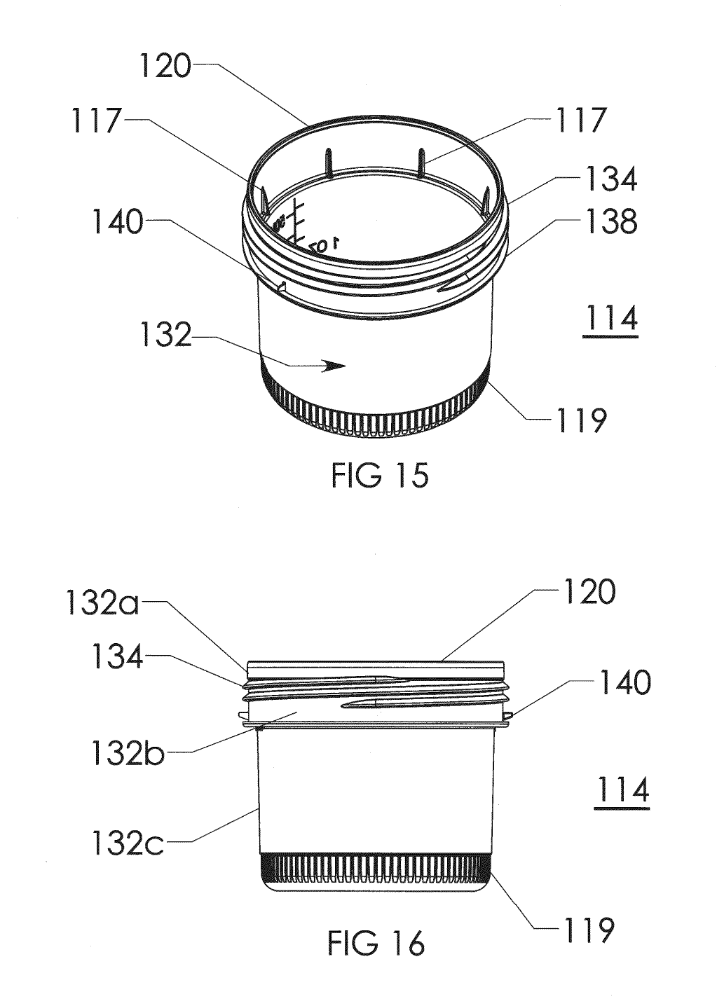

A specimen collection container in accordance with one embodiment of the invention is shown in FIGS. 1-14 and is designated generally by reference numeral 10. An additional embodiment of the invention is illustrated in FIGS. 15-18. Although the invention is described below as a specimen collection container, it should be appreciated by those of ordinary skill in the art that the invention is not limited to use in connection with collection and containment of patient specimens; rather, the invention may include use of the container for collecting, storing and/or transporting fluids of any type.

The container 10 generally comprises a cap and a collection cup, designated generally by reference numerals 12, 14, respectively. The cap 12 and collection cup 14 have cooperatively engaging threads, 22, 34, respectively. The cap 12 includes a sealing mechanism, designated generally by reference numeral 16, which engages and seals the open end of the collection cup 14.

The cap 12 and cup 14 have cylindrical shapes with one circular closed end. As used hereinafter, the term “axially-extending” refers to the direction parallel to the central axis of the cylinder, and the term “radially-extending” refers to the direction parallel to a radius of the circular closed end of the cylinder.

In an embodiment of the invention, the cap 12 has a central, top wall 18, an annular side wall 20 extending generally transverse to the plane of the top wall 18, and protruding threads 22 on the inner surface of the side wall 20. The side wall 20 has a cylindrical shape, extends from the periphery of the top wall 18, and terminates at a distal edge 20c. As best seen in FIGS. 1 and 2, the top wall 18 has a raised, annular portion 18a on the periphery, a circular central portion 18b, and a concave (relative to the exterior of the cap) depression 18c in the center of the central portion 18b. The three portions 18a-c form the continuous surface of the top wall 18 of the cap 12.

Referring to FIGS. 1 and 3, the exterior of the side wall 20 has a textured or knurled outer surface so that the cap can be more easily gripped during rotation. In the embodiment shown in FIGS. 1 and 3, the exterior surface includes a plurality of equally-spaced, radially-projecting ridges or gussets 24. The ridges 24 are preferably integrally formed on the exterior surface and may have any shape that makes the cap easier to grip during turning. The ridges 24 also stiffen the side wall 20 to prevent distortion during gripping and during significant pressure changes.

In the embodiment shown in FIGS. 1-14, the ridges 24 are equally spaced around the entire circumference of the side wall 20. However, the ridges 24 may be provided on less than the entire circumference of the wall 20. In an alternative embodiment, the ridges 24 are provided around the cap circumference at select locations where a gripping force maximizes the effectiveness of the unique features of the collection container 10, described below.

In the embodiment shown in FIGS. 1-14, the ridges 24 extend axially only along a partial, upper portion 20a (relative to the top surface) of the side annular wall 20, thereby defining a smooth, lower (relative to the top surface) band 20b. In this embodiment, the ridges are located and opposed axial locations to the sealing mechanism 16 and stiffen the portion of the wall to which the inner sealing mechanism is attached. However, in other embodiments, the ridges 24 may extend along the entire axial length of the side wall 20.

As best seen in FIGS. 4-5, the interior surface of the central, circular portion 18b includes a plurality of radially-projecting strengthening ribs 26, which are integrally formed in the central top wall 18 and extend axially along. In the embodiment shown in FIGS. 1-14, the ribs 26 extend from the outer periphery of the central portion 18b to the central depression 18c. The ribs 26 provide increased rigidity to the large, flat central portion of the cap, which might otherwise deflect or deform under significant pressure changes. In the embodiment shown in FIGS. 1-14, the ribs 26 extend only partially into the central depression 18c since the shape of the central depression provides increased rigidity compared to a flat surface. However, in another embodiment, the ribs may extend fully to the center of the depression 18c to further increase the rigidity of the central top wall 18. The shape and construction of the top wall 18 add rigidity to the top wall 18, which helps prevent distortion of the cap under significant pressure change.

Referring to FIGS. 4 and 5, the inner surface of the side wall 20 includes protruding threads 22 that cooperate with threads 34 on the outer surface of the cup 14, described below. The threads 22 initiate at an intermediate point along the axial length of the side wall 20 and terminate at a second intermediate point below the top wall 18. The inner annular surface above and below the threaded portion has a generally smooth interior.

In the embodiment shown in FIGS. 1-14, the cup 14 of the collection container 10 has a central, bottom wall 30, an annular side wall 32 extending generally transverse to the plane of the bottom wall 30, and protruding threads 34 on the exterior surface of the side wall 32. The side wall 32 extends from the periphery of the bottom top wall 30 and terminates at a distal edge 20c.

As best seen in FIGS. 7 and 8, the central bottom wall 32 has a circular, flat construction and the side wall 32 has a cylindrical shape. The outer surface of the side wall 32 has an upper (relative to the bottom wall 30) section 32a, intermediate section 32b, and a lower section 32c. The three portions 32a-c form the continuous outer surface of the side wall 32 of the cup 14. The inner surface of the side wall 32 is smooth along its entire axial length. The thickness of the side wall 32 is generally uniform along it axial length.

In one embodiment, the upper section 32a has a smooth outer surface and an axial length of about 3.4 millimeters. The upper section 32a engages the seal mechanism, described below, of the cap 12.

In one embodiment, the intermediate section 32b has protruding threads 34 and an axial length of about 9.3 millimeters. The threads 34 cooperatively engage the threads 22 on the cap 12.

The lower section 32c has a smooth outer surface and an axial length of about 29.2 millimeters, although the length may vary depending on the size of the container 10. A strengthening ring 38 extends around the periphery of the cup 14 and generally demarcates the boundary between the intermediate section 32b and the lower section 32c. The ring 38 prevents distortion of the cup 14 under significant pressure changes or during installation of the cap.

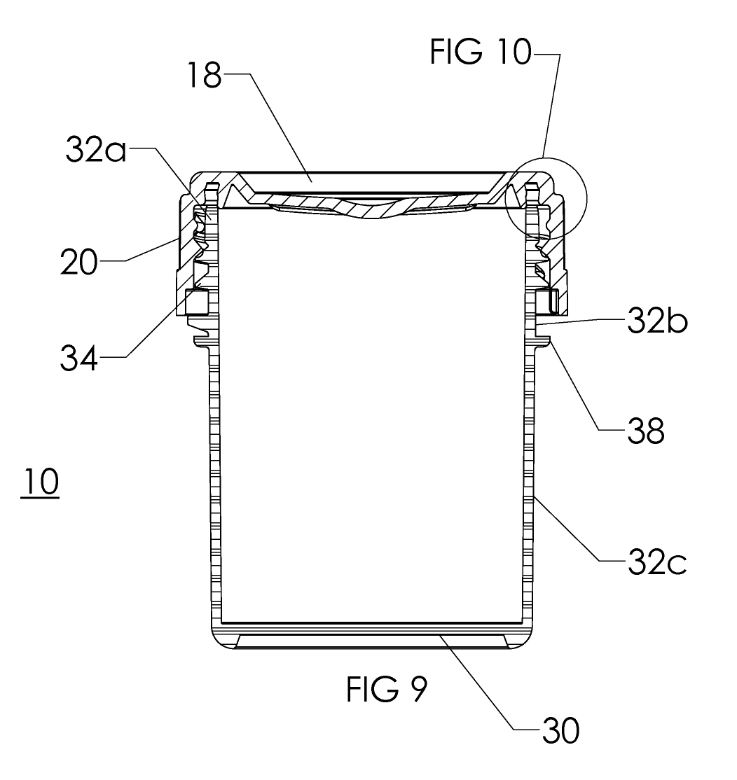

The sealing mechanism 16 in accordance with an embodiment of the invention is best described with reference to FIGS. 9-14. The sealing mechanism 16 is incorporated in the cap 12 and engages the upper section 32a and distal edge of the cup 14. The sealing mechanism 16 generally comprises an annular plug 42, an annular seat 44, and an annular support bead 46. In general, the annular plug 42 forms primary and secondary plug seals 52a, 52b with the interior surface of the cup 14. The annular seat 44 has a shape that compliments and forms a tertiary seal 52c with the distal edge 32d of the cup 14. The support bead 46 has primary and secondary supports 46a, 46b on the inner surface of the upper portion of the cup 14 at locations generally opposed to the locations of the primary and secondary seals 52a, 52b.

As best seen in FIGS. 5, 10, 12 and 14, the annular plug 42 is integrally formed with and extends axially downwardly (relative to the top wall 18) from the top wall 18. The annular plug 42 includes an inner plug surface 50, an outer plug surface 52 and a distal end surface 54. The inner plug surface 50 has a flat, regular geometry and extends axially at an obtuse angle relative the plane of the central portion 18b of the cap 12.

The outer plug surface 52 has an irregular geometry and also extends generally axially at an obtuse angle relative to the plane of the central portion 18b of the cap 12. The outer plug surface 52 has a primary seal 52a and secondary seal 52b, which contact the inner surface of the upper portion 32a of the sidewall of the cup 14. In the embodiment shown in FIGS. 1-14, the primary and secondary seals 52a, 52b comprise protrusions on the outer plug surface 52. However, in alternative embodiments, the primary and secondary seals 52a, 52b may comprise separate seal elements formed in or fixed to the outer plug surface 52. The distal end surface 54 is generally flat with rounded corners and extends between the inner and outer plug surfaces.

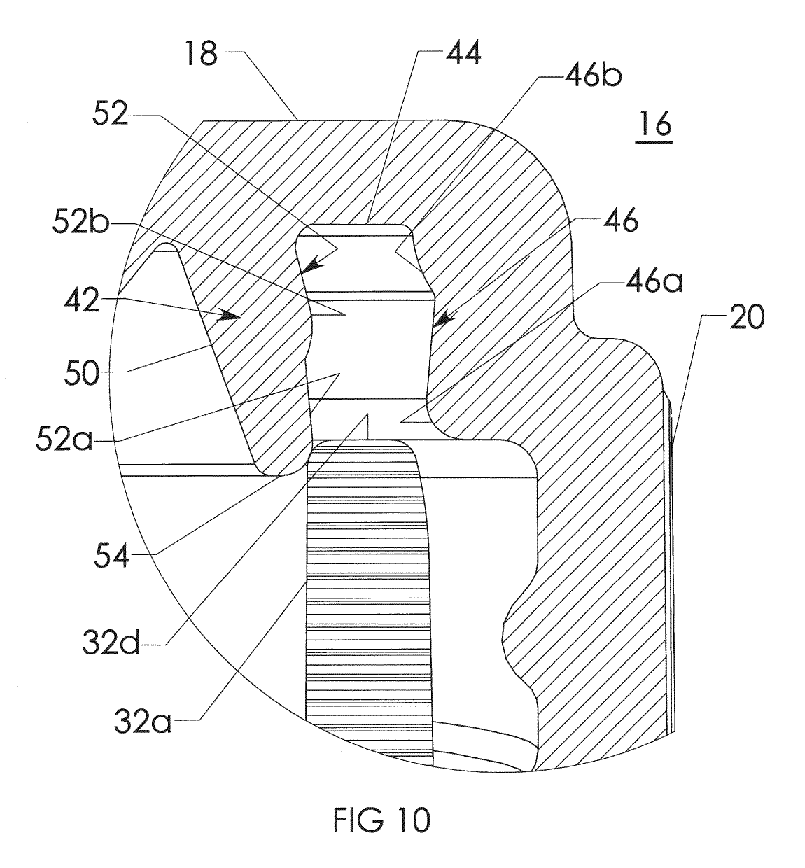

The annular seat 44 is formed intermediate the annular plug 42 and support bead 46. Referring to FIGS. 10, 12 and 14, the seat 44 is generally flat and extends around the periphery of the cap 12. In the embodiment shown in FIGS. 1-14, the seat 44 is integrally formed on the top wall 18. However, in alternative embodiments, the seat 44 may comprise one or more separate seat elements formed in or fixed to the top wall 18 of the cap 12.

The annular support bead 46 has an irregular geometry and also extends generally axially relative to the plane of the central portion 18b of the cap 12. In the embodiment shown in FIGS. 1-14, the support bead 46 is integrally formed on the upper, interior surface of the side wall 20 of the cap 12. However, in alternative embodiments, the support bead 46 may comprise one or more separate bead elements formed in or fixed to the side wall 20 of the cap 12.

The annular support bead 46 has a primary support 46a and secondary support 46b, which contact the outer surface of the cup 14. In the embodiment shown in FIGS. 1-14, the primary and secondary supports 46a, 46b comprise protrusions on the support bead 46. However, in alternative embodiments, the primary and secondary supports 46a, 46b may comprise separate support elements formed in or fixed to the side wall 20 of the cap 12.

The construction and operation of the plurality of seals in the seal mechanism 16 is illustrated in FIGS. 10, 12, and 14. FIG. 10 illustrates the container 10 after the cap has been installed on the cup 14 and partially tightened by rotating the cap approximately ¼ of a revolution. In this first position, the primary seal 52a of the plug 46 first engages the inner surface of the cup 14. In this first position, the container 10 is sealed by the primary seal 52a.

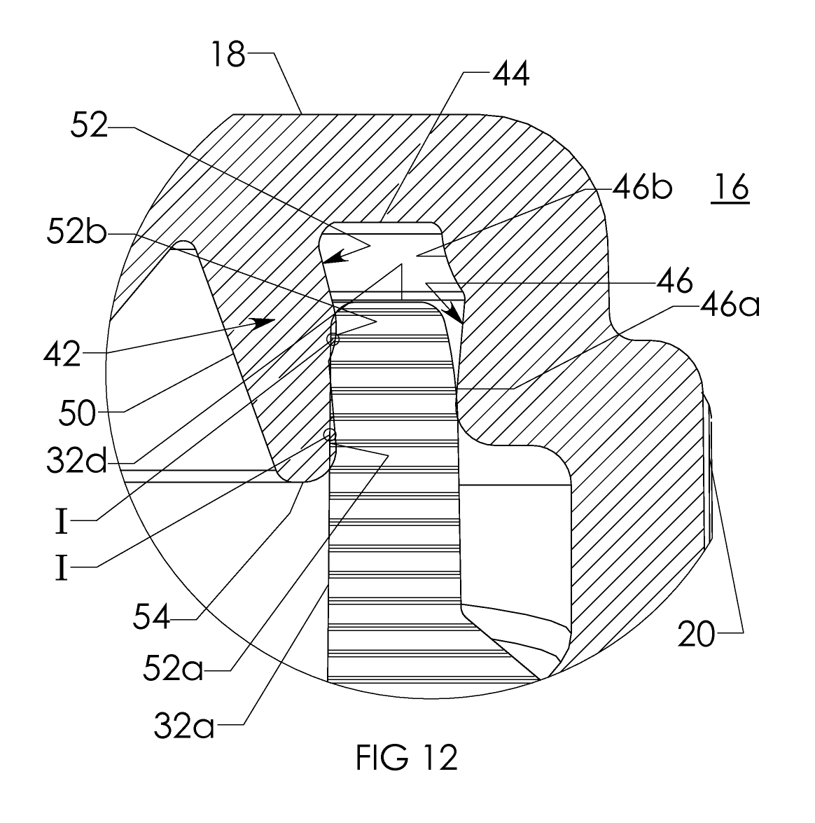

FIG. 12 illustrates the container 10 after the cap 12 has been more fully tightened by rotating the cap 12 approximately an additional ¼ revolution. In this second position, the secondary seal 52b also engages the inner surface of the cup 14. The primary seal 52a remains in contact with the inner surface of the cup 14 but has moved axially downwardly into the cup 14. In the second position, the primary support 46a also engages the outer surface of the cup 14. In this second position, the container is sealed with both the primary and secondary seals 52a, 52b.

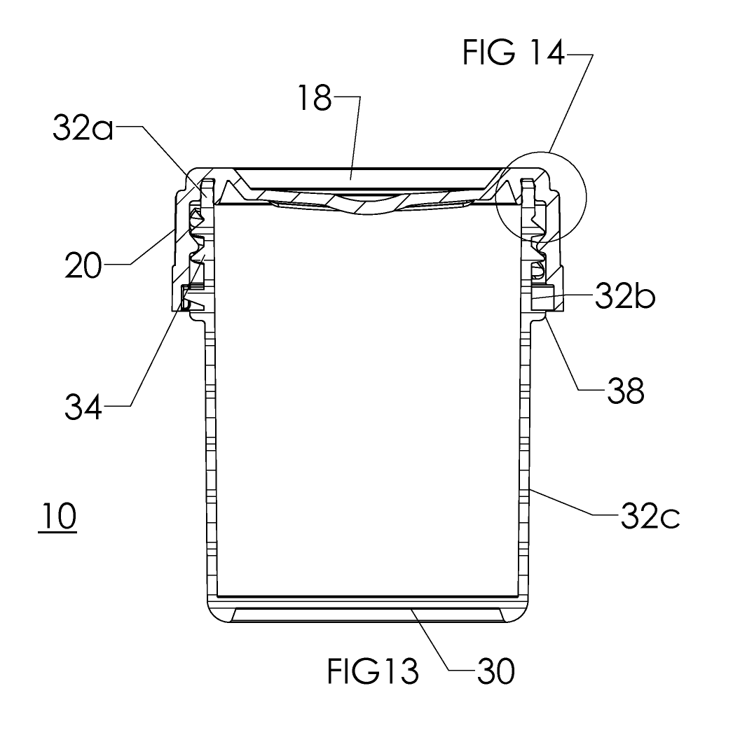

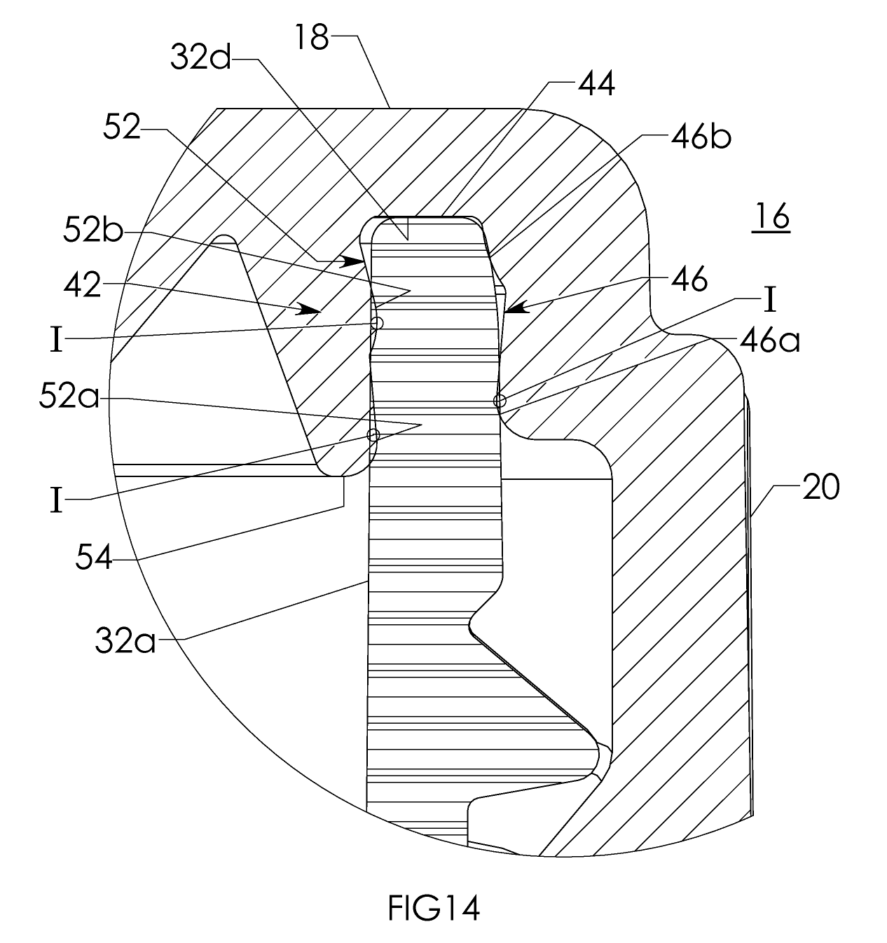

FIG. 14 illustrates the container after the cap 12 has been fully tightened by rotating the cap 12 by approximately a final ¼ revolution. In this third position, the tertiary seal 52c engages the distal edge 32d of the cup 14. The primary seal 52a and secondary seal 52b remain in contact with the inner surface of the cup 14 but have moved axially downwardly into the cup 14. The primary support 46a also remains in contact with the outer surface of the cup 14 but has moved axially downwardly. In the fully closed position, the second support 46b also engages the outer surface of the cup 14. As best seen in FIG. 12, the primary and secondary supports 46a, 46b engage the outer surface at about the same axial location as the primary and secondary seals 52a, 52b, respectively, but on opposite sides (inner vs. outer) of the upper portion 32a of side wall 32.

In the preferred embodiment, the cap 12 and cup 14 are preferably made from a deformable thermoplastic material such as polypropylene using known injection molding techniques. The seals and supports of the cap rely on the deformability and flexibility of the material to function properly. In FIGS. 12 and 14, an overlap or interference between the upper portion 32a of the side wall 32, the annular plug 42 and annular support bead 46 are indicated by reference letter “I” at multiple locations. At these locations, the side wall 32 does not compress or deform. Rather, the various components of the sealing mechanism deform. However, in FIGS. 12 and 14 the original configuration of the sealing mechanism components are shown in their original, uncompressed/deformed shape to better illustrate the locations of the several seals and supports.

With respect to identifying the seals, the terms primary, secondary and tertiary are not necessarily used to denote importance or sealing capacity. Instead, the terms primary, secondary, and tertiary indicate the order in which the seals engage the side wall 32 of the cup 14 during closing of the cap 12.

The sealing mechanism 16 of the present invention has several advantages over prior art container seals. The integrity of the tertiary seal 52c of applicant's sealing mechanism 16 relies on a sufficient amount of torque being applied to the cap to press the distal edge 32d of the cup 14 into the annular seat 44 with sufficient force to form a seal. In contrast, the primary and secondary seal 52a, 52b of the sealing mechanism 16 do not rely on significant patient torque to form the seal. The primary and secondary seals 52a, 52b are formed when the plug 42 enters the opening of the cup 14. Only a very small amount of torque is required to rotate the cap to a position wherein the primary and secondary seals 52a, 52b engage the inner surface of the cup 14. Therefore, even if the patient does not provide sufficient torque to fully close the cap and engage the tertiary seal 52c, the container remains sealed by the primary and secondary seals 52a, 52b.

In the fully-closed position, the container 14 has three separate seals and two separate seal supports. The cap 12 also has strengthening ribs 38 in the central top wall 18. The supports and ribs prevent the cup 14 from deforming under significant pressure changes. Since the cup 14 does not deform, the upper portion 32a of the cup 14 does not disengage from any of the seals.

In a preferred embodiment, the container 10 includes a detent mechanism that makes an audible “click” sound when the cap has been tightened sufficiently to engage all three seals of the sealing mechanism 16. In the embodiment shown in FIGS. 1-14, two tabs 28 extend radially-inwardly from the inner surface of the cap proximate the distal edge 20c. In the embodiment shown in FIGS. 1-14, the tabs 28 are diametrically opposed and integrally formed with the annular wall. Two detents 40 extend radially from the intermediate section 32b of the cup 14 below the threads 34. In this embodiment, the detents 40 comprise integrally-formed, flexible protrusions that are axially positioned to engage the tabs 28 when the cap is tightened fully enough to engage each of the three seals.

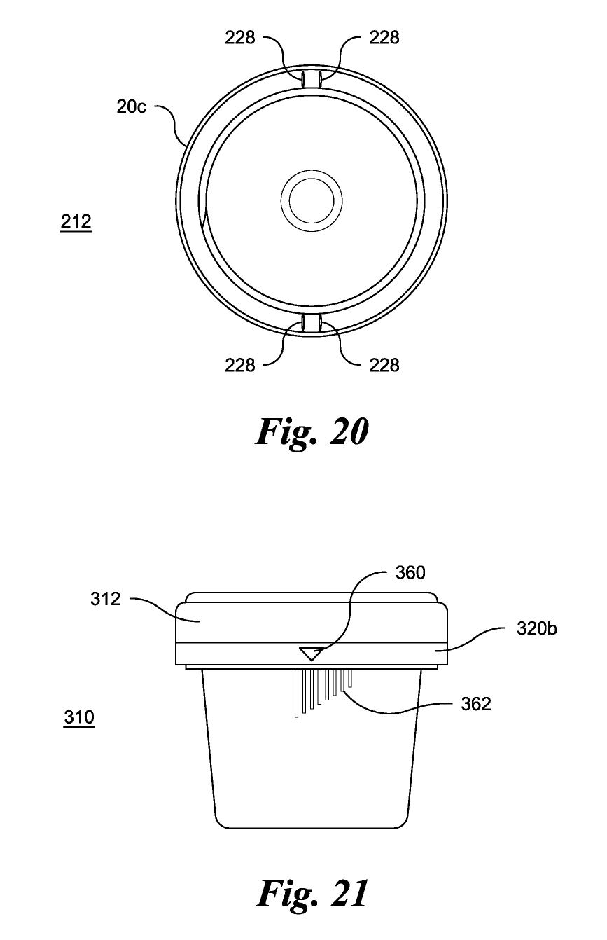

In another embodiment, shown in FIGS. 20-25, the detent mechanism comprises two pair of tabs, which extend radially-inwardly from the inner surface of the cap proximate the distal edge 20c. In this embodiment, the tabs have the same construction as described above with respect to tabs 28; however, due to this dual construction, the tabs makes an audible “double-click” sound when the cap has been tightened sufficiently to engage all three seals of the sealing mechanism 16.

A specimen collection cup 114 container in accordance with another embodiment of the invention is shown in FIGS. 15-19. The cup 114 has a construction similar to the construction of the cup 14 described above. In the embodiment shown in FIGS. 15-19, the cup 114 has a central, bottom wall 130, an annular side wall 132 extending generally transverse to the plane of the bottom wall 130, and protruding threads 134 on the exterior surface of the side wall 132. The side wall 132 extends from the periphery of the bottom wall 130 and terminates at a distal edge 120.

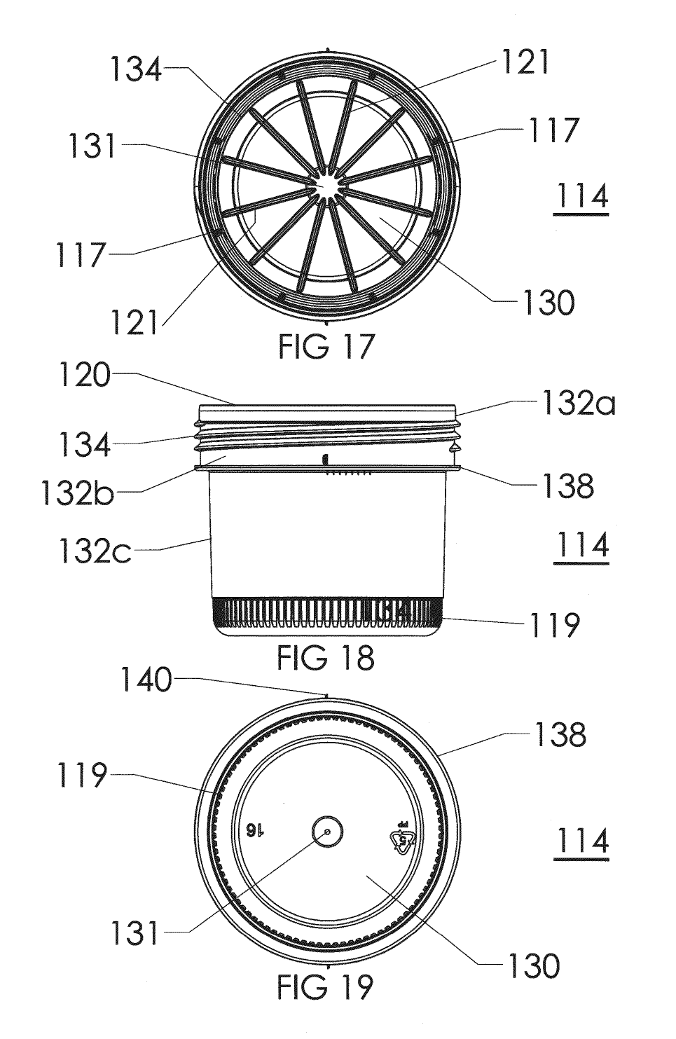

As best seen in FIGS. 17 and 19, the cup has a circular bottom wall 130 and the side wall 132 has a cylindrical shape. The outer surface of the side wall 132 has an upper (relative to the bottom wall 130) section 132a, intermediate section 132b, and a lower section 132c. The three portions 132a-c form the continuous surface of the side wall 132 of the cup 114. The inner surface of the side wall 132 is smooth along its entire axial length. The thickness of the side wall 132 is generally uniform along it axial length.

The upper section 132a has a smooth outer surface and an axial length of about 2.5 millimeters. The upper section 132a is constructed to engage the seal mechanism 16 of the cap 12 described above.

The intermediate section 132b has protruding threads 34 and an axial length of about 10 millimeters. The threads 134 are constructed to cooperatively engage the threads 22 on the cap 12 described above.

The lower section 132c has a smooth outer surface and an axial length of about 35 millimeters, although the length may vary depending on the size of the container 10. A strengthening ring 138 extends around the periphery of the cup 114 and generally demarcates the boundary between the intermediate section 132b and the lower section 132c. The ring 138 prevents distortion of the cup 114 under significant pressure changes or during installation of the cap.

In this embodiment, the ring 138 also defines a shoulder at which the diameter of the cup changes between the intermediate section 132b and the lower section 132c. In this embodiment, the diameter of the lower section 132c is slightly smaller than the diameter of the intermediate section 132b and the upper section 132a. Preferably, the lower section has a slightly tapered diameter to allow the cups to be stacked on top of each other.

In the embodiment show in FIGS. 15-19, the cup and cap are larger than prior art specimen containers. For example, in the embodiment shown in FIGS. 15-19, the cup 114 has volumetric capacity of about 50 ml. Therefore, the cup 114 includes additional stiffening features, compared to the cup 14 described above, to help prevent distortion of the cup 114 during significant pressure changes. Because of the increased size of the cup, the bottom wall of the cup 114 includes a plurality of radially-projecting strengthening ribs 120, which are integrally formed in the bottom wall 130, and a central depression 131. In the embodiment shown in FIGS. 15-19, the ribs 120 extend from the outer periphery of the bottom wall to a central depression. The ribs 121 provide increased rigidity to the large flat bottom wall of the cup 114, which might otherwise deflect or deform under significant pressure changes. In the embodiment shown in FIGS. 15-19, the ribs 120 extend only partially into the central depression 131 since the shape of the central depression 131 provides increased rigidity compared to a flat surface. However, in another embodiment, the ribs may extend fully to the center of the depression 131 to further increase the rigidity of the bottom wall.

The cup 114 also includes a plurality of gussets 117 on the threaded, interior, intermediate portion 132b of the side wall 132. As best seen in FIG. 15, the gussets 117 are integrally formed on and connect both the shoulder and the inner surface of the intermediate portion 132b. The gussets add rigidity to the cup 114, which has a diameter much larger than prior art containers.

Referring to FIGS. 20-26, the specimen collection container of this embodiment include a visual indicator that that informs the user whether or not the cap is fully closed on the cup. In this embodiment, the indicator is similar to the indicator disclosed in U.S. patent application Ser. No. 10/998,165 entitled Biological Specimen Collection Container, filed Jun. 23, 2005, incorporated herein by reference. The indicator comprises a arrow on the outer annular surface of the cap and a plurality of individual bars of increasing length on the outer surface of the cup. When the arrow on the cap is positioned over any one of the bars, the cap has been torqued sufficiently to fully close the cap and engage all three seals. Preferably, the user torques the cap until the arrow aligns with the longest bar on the cup.

While the principles of the invention have been described above in connection with specific embodiments, it is to be clearly understood that this description is made only by way of example and not as a limitation on the scope of the invention.

1. A specimen collection container, comprising:
a) a cup having a closed bottom end and an open upper end, a bottom surface at the closed end, sidewalls extending from the periphery of the bottom surface and terminating at a distal upper edge, and threads formed on the upper, outer surface of the side walls;
b) a cap having a closed top end and an open bottom end, a top surface at the closed upper end, sidewalls extending from the periphery of the top surface and terminating at a distal lower edge, and threads formed on the interior surface of the side walls that compliment and engage said threads on said cup to open and close said cap on said cup; and,
c) a sealing mechanism that forms primary, secondary and tertiary seals between the cap the cup.

2. The specimen collection container recited in claim 1, wherein the primary and secondary seals are formed between the cap and the interior surface of the cup, and the tertiary seal is formed between the cap and the distal edge of the cup.

3. The specimen collection container recited in claim 1, wherein said primary and secondary seal comprises a plug that extends from the cap and engages the interior surface of the cup at two separate locations.

4. The specimen collection container recited in claim 1, wherein said tertiary seal comprises an annular seat in the cap having a shape that compliments the shape as the distal edge of cup.

5. The specimen collection container recited in claim 2, including a support on said cap that engages the outer surface of the cup at two locations generally opposed to the seal locations of the primary and secondary seals.

6. The specimen collection container recited in claim 3, wherein the plug is integrally formed with and extends downwardly from the top wall of the cap, and has an inner plug surface, an outer plug surface and a distal end surface.

7. The specimen collection container recited in claim 6, wherein the inner plug surface has a flat, regular geometry and extends axially at an obtuse angle relative to the plane of the central portion of the cap, and the outer plug surface has an irregular geometry and also extends at an obtuse angle relative to the plane of the central portion of the cap.

8. Thee specimen collection container recited in claim 7, wherein the outer plug surface has a primary seal and a secondary seal, which contact the inner surface of the upper portion of the sidewall of the cup.

9. The specimen collection container recited in claim 3, wherein the primary seal and secondary seal comprise protrusions on the outer plug surface.

10. The specimen collection container recited in claim 1, said cap including reinforcing means on said top surface and said sidewall.

11. The specimen collection container recited in claim 1, said cup including reinforcing means on said sidewall.

12. The specimen collection container recited in claim 1, wherein said first, second and third seals are sequentially formed as the cap is rotated from a first radial position at which the threads first engage each other to a second radial location at which the cap is fully closed.

13. The specimen collection container recited in claim 12, wherein each of the three seals on its own is capable of sealing the container and preventing a fluid specimen from leaking from the cup if said seal is maintained.

14. The specimen collection container recited in claim 12, including an indicator that informs the user whether or not the cap is fully closed on the cup.

15. The specimen collection container recited in claim 14, wherein said indicator comprises a detent mechanism that creates at least one audible click sound when the cap is full closed.

16. The specimen collection container recited in claim 1, wherein said cap reinforcing means comprises a plurality of radially-projecting strengthening ribs on the interior surface of the central, circular portion, and a plurality of equally-spaced, radially-projecting gussets on the outer surface.

17. The specimen collection container recited in claim 11, wherein said cup reinforcing means comprises a strengthening ring that extends around the periphery of the outer surface.

18. The specimen collection container recited in claim 4, wherein the annular seat is integrally formed on said cap intermediate the annular plug and support bead.

19. The specimen collection recited in claim 11, said cup including reinforcing means on said bottom surface comprising a plurality of radially-extending strengthening ribs.

20. A specimen collection container, comprising:
a) a cup having a bottom surface at the closed end, sidewalls extending from the periphery of the bottom surface and terminating at a distal upper edge, and threads formed on the upper, outer surface of the side walls;
b) a cap having a closed top end and an open bottom end, a top surface at the closed upper end, sidewalls extending from the periphery of the top surface and terminating at a distal lower edge, and threads formed on the interior surface of the side walls; and,
c) a sealing mechanism that forms multiple seals between the cap the cup; and,
d) a support mechanism that contacts the cup on the opposite side and at opposed locations to at least one of the seals to reduce the distortive effective of said seals contacting said cup.

21. The specimen collection container recited in claim 20, wherein said first, second and third seals are sequentially formed as the cap is rotated from a first radial position at which the threads first engage each other to a second radial location at which the cap is fully closed.

22. The specimen collection container recited in claim 21, wherein said support mechanism contacts the cup on the opposite side and at opposed locations to the primary and secondary seals.

23. The specimen collection container recited in claim 22, wherein said primary and secondary seals are constructed and arranged to seal said cup after said cup and cap are threadingly engaged independent of the amount of torque applied to the cap.

24. A specimen collection container, comprising:
a) a cup having a bottom surface at a closed end, sidewalls extending from the periphery of the bottom surface and terminating at a distal upper edge, and threads formed on the upper, outer surface of the side walls;
b) a cap having a closed top end and an open bottom end, a top surface at the closed upper end, sidewalls extending from the periphery of the top surface and terminating at a distal lower edge, and threads formed on the interior surface of the side walls that engage the threads on the cup; and,
c) a sealing mechanism that creates primary, secondary and tertiary seals between the cap the cup;
wherein at least one of said seals is constructed and arranged to seal said cup after said cup and cap are threadingly engaged independent of the amount of torque applied to the cap

25. The specimen collection container recited in claim 24, wherein said first, second and third seals are sequentially formed as the cap is rotated from a first radial position at which the threads first engage each other to a second radial location at which the cap is fully closed.

26. The specimen collection container recited in claim 24, wherein said primary and secondary seals are constructed and arranged to seal said cup after said cup and cap are threadingly engaged independent of the amount of torque applied to the cap.

27. The specimen collection container recited in claim 24, including a support mechanism that contacts the cup on the opposite side and at opposed locations to at least one of said primary and secondary seals to reduce the distortive effective of said seals contacting said cup.
